(19) United States
(12) Patent Application Publication
(10) Pub. No.: US 2003/0154143 A1
(43) Pub. Date: Aug. 14, 2003

(54) Collaborative system and method for monitoring imported and exported goods

(76) Inventor: Mickey Chen, Tu-Chen (TW)

Correspondence Address: Wei Te (Joseph) Chung, Foxconn International, Inc., 1650 Memorex Drive, Santa Clara, CA, 95050, US

(21) Appl. No.: 10/158,749

(22) Filed: May 29, 2002

(30) Foreign Application Priority Data
Feb. 8, 2002 (TW) 91102461

(51) Int. Cl. G06F 17/60

(52) U.S. Cl. 705/28; 705/1; 705/26

(57) ABSTRACT

A collaborative system for monitoring imported and exported goods comprises a database (22), a database server (2) connected with the database, and a web server (4) for exchanging information between users and the database via an electronic communications network (7). The database server is electronically connected with an internal system (8) of a corporation, and automatically obtains information related to all import and export business activities including purchase, production, storage, sales and declarations for import and export. A user sends a query to the web server through a client computer (6). The web server transforms the query into a predetermined format, and transmits the transformed query to the database server. The database server automatically searches the database to obtain a query result, which is then transmitted to the web server. The web server transforms the query result into another predetermined format, and transmits the query result to the client computer.

### FIELD OF THE INVENTION

This invention is related to collaborative systems and methods for monitoring imported and exported goods via electronic communications networks, and especially to collaborative systems and methods for monitoring in a timely manner all import and export business activities including purchase, production, storage, sales and declarations for import and export.

### BACKGROUND OF THE INVENTION

Declaring goods for import and export is generally a complex activity. Nonetheless, import and export of goods is important for many corporations to improve production and capital turnover. Conventionally, corporations and a customs authority of a government operate quite independently of each other, with only limited collaboration. When a corporation needs to declare goods for import or export, the corporation prepares the required hardcopy documents and submits such documents to customs for examination before the goods cross the customs frontier. Customs examines the correctness and validity of the documents in light of applicable customs laws and regulations. Sometimes, customs needs to re-examine the documents. When the goods cross the customs frontier, customs checks the goods according to information supplied in the documents. The procedures for declaration and examination are many and various. Corporations which conduct substantial international trade have to constantly submit declarations for import and export of goods. Conventional declaration procedures are excessively time-consuming, and can seriously disrupt short production schedules and the fluctuating requirements imposed on a corporation by prevailing market conditions. Further, customs has to expend considerable time and manpower to handle an excessively large amount of documents. Accordingly, customs may suffer from a shortage of timely information needed to properly monitor all activities of a corporation. In such cases, customs may be unable to carry out its duties effectively.

Accordingly, it is desired to provide a system and method which overcomes the abovementioned disadvantages.

### SUMMARY OF THE INVENTION

A primary object of the present invention is to provide a system and method electronically connecting an organization and customs to improve the efficiency of declaration procedures for import and export of goods, and to enable customs to monitor in a timely manner all relevant business activities of the organization including purchase, production, storage, sales and declarations for import and export.

Another object of the present invention is to provide a collaborative system and method for monitoring imported and exported goods which enables an organization and customs to collaborate efficiently and to save much labor and time.

In one aspect of the present invention, a collaborative system for monitoring imported and exported goods is provided. The system comprises a database for storing information on import and export business activities, a database server connected with the database, and a web server for exchanging information between users and the database via an electronic communications network. The database server is electronically connected with an internal system of a corporation, and automatically obtains information related to all import and export business activities including purchase, production, storage, sales and declarations for import and export. The web server comprises a goods recording module, a purchasing module, a sales module, and an inventory module. The goods recording module is for obtaining from the database information that is required to be put on record in a customs authority. The purchasing module is for obtaining from the database purchasing information and declaration information on imported goods. The sales module is for accessing the database for sales information and declaration information on exported goods. The inventory module is for accessing the database for information on finished goods, usage of materials and current inventory.

In another aspect of the present invention, a collaborative method for monitoring imported and exported goods comprises the following steps: providing a database for storing information on import and export business activities; and providing a web server for exchanging information between users and the database via an electronic communications network. The web server database comprises a goods recording module, a purchasing module, a sales module, and an inventory module. The goods recording module is for obtaining from the database information that is required to be put on record in a customs authority. The purchasing module is for obtaining from the database purchasing information and declaration information on imported goods. The sales module is for accessing the database for sales information and declaration information on exported goods. The inventory module is for accessing the database for information on finished goods, usage of materials and current inventory.

These and other objects and features of the present invention will become more fully apparent from the following description and appended claims, or may be learned by the practice of the invention as set forth hereinafter.

### BRIEF DESCRIPTION OF THE DRAWINGS

FIG. 1 shows hardware architecture of a collaborative system for monitoring imported and exported goods in accordance with a preferred embodiment of the present invention;

FIG. 2 shows a data source flow chart of the collaborative system for monitoring imported and exported goods of FIG. 1;

FIG. 3 is an information flow chart of the collaborative system for monitoring imported and exported goods of FIG. 1; and

FIG. 4 is a schematic structure of a Browser/Server (B/S) mode of operation of the collaborative system for monitoring imported and exported goods of FIG. 1.

### DETAILED DESCRIPTION OF THE PREFERRED EMBODIMENT

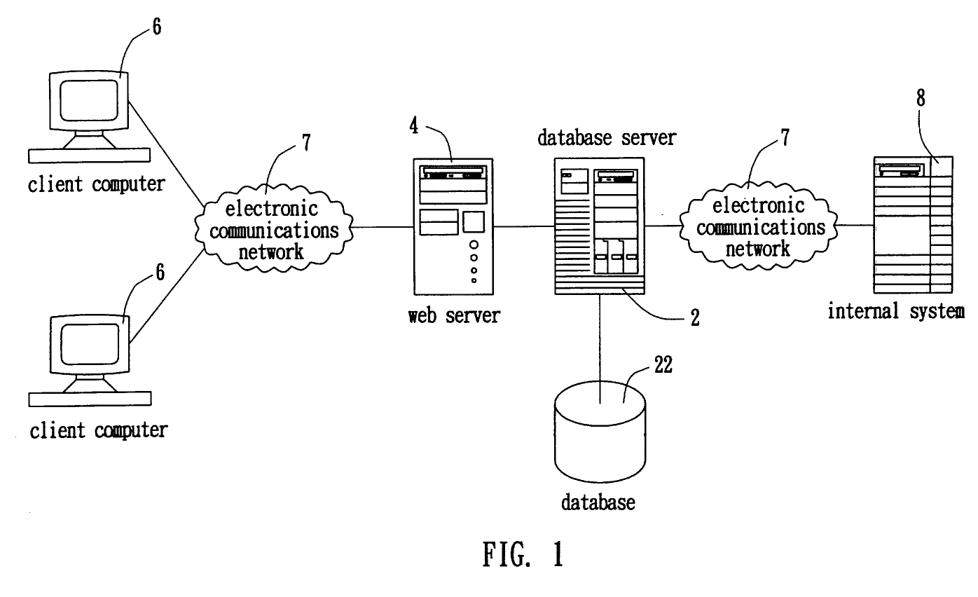

FIG. 1 shows hardware architecture of a collaborative system for monitoring imported and exported goods in accordance with a preferred embodiment of the present invention. The collaborative system for monitoring imported and exported goods comprises a database server 2, a web server 4, an internal system 8, and a plurality of client computers 6. The database server 2 is connected with a database 22, the database 22 being a relational database such as Informix. The database server 2 is for sending data to or receiving data from the database 22. The database server 2 obtains information from an internal system 8 via an electronic communications network 7, and stores the information in the database 22. The electronic communications network 7 may, for example, be an intranet or the Internet. The web server 4 is for transforming information received in a first format into information in a second format and vice versa, in order that the information can be exchanged between the database server 2 and the client computers 6 via the electronic communications network 7. The internal system 8 is a management system which helps to control all activities of an organization. For the purposes of describing the preferred embodiment, the organization is hereinafter assumed to be a corporation. An exemplary internal system 8 is an Enterprise Resource Planning (ERP) system. The information obtained from the internal system 8 is related to import and export business activities. Such activities typically include purchase, production, storage, sales and declarations. Users, including staff of the corporation and customs inspectors, access the information stored in the database 22 through the client computers 6.

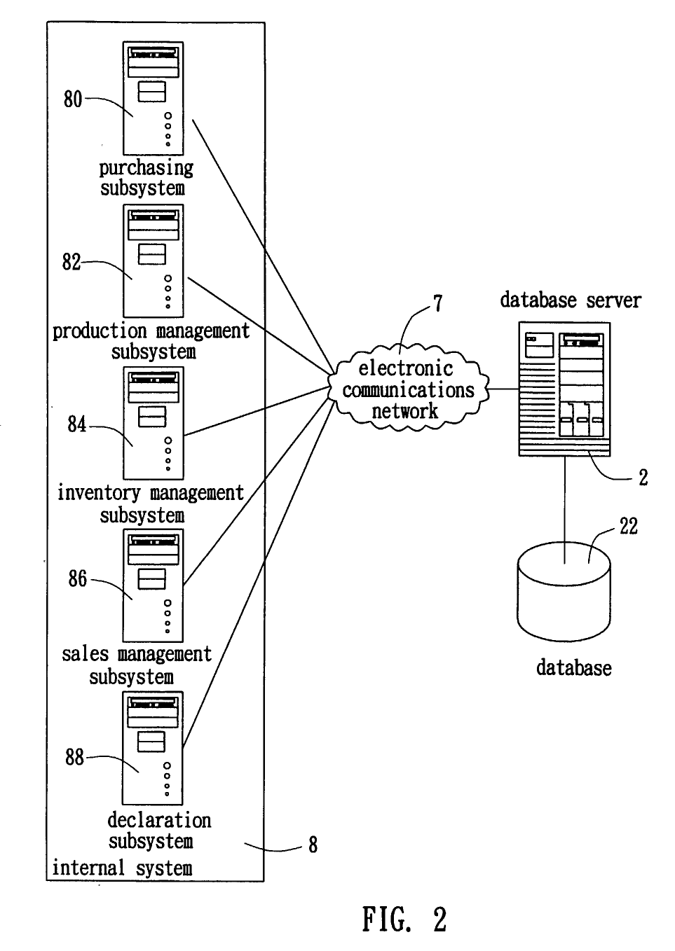

FIG. 2 shows a data source flow chart of the collaborative system for monitoring imported and exported goods. The internal system 8 comprises a purchasing subsystem 80, a production management subsystem 82, an inventory management subsystem 84, a sales management subsystem 86, and a declaration subsystem 88. When a purchasing officer of the corporation inputs information related to purchased goods to the purchasing subsystem 80, the collaborative system for monitoring imported and exported goods automatically determines whether the purchased goods concern import or export. If the purchased goods concern import or export, the input information is automatically transferred to the database server 2 and stored in the database 22. W hen performing production tasks, a production manager of the corporation inputs information related to production into the production management subsystem 82. If the input information concerns import or export, the input information is automatically transferred to the database server 2 and stored in the database 22. In the same manner, inventory information concerning import or export is automatically transferred to the database server 2 from the inventory management subsystem 84, sales information concerning import or export is automatically transferred to the database server 2 from the sales management subsystem 86, and declaration information concerning import or export is automatically transferred to the database server 2 from the declaration subsystem 88. All the aforesaid information is stored in the database 22.

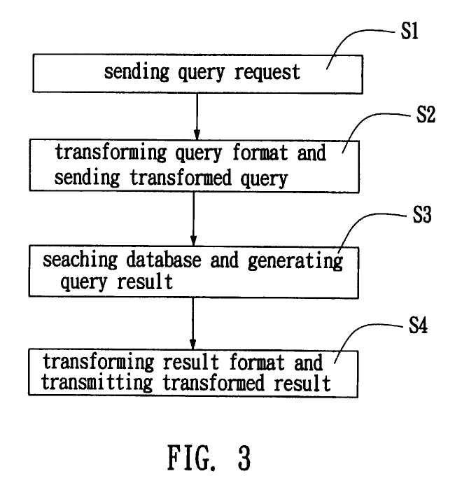

FIG. 3 shows an information flow chart of the collaborative system for monitoring imported and exported goods. A user, such as a member of the corporation or of customs, sends a query request to the web server 4 through one of the client computers 6 (step S1). Upon receiving the query request from the client computer 6, the web server 4 automatically transforms the query request into query request information in a standard format, and sends the query request information to the database server 2 (step S2). Based on the query request information from the web server 4, the database server 2 searches the database 22 thoroughly, generates a query result, and transmits the query result to the web server 4 (step S3). Finally, the web server 4 automatically transforms the query result into query result information in a standard format, and sends the query result information to the client computer 6 (step S4).

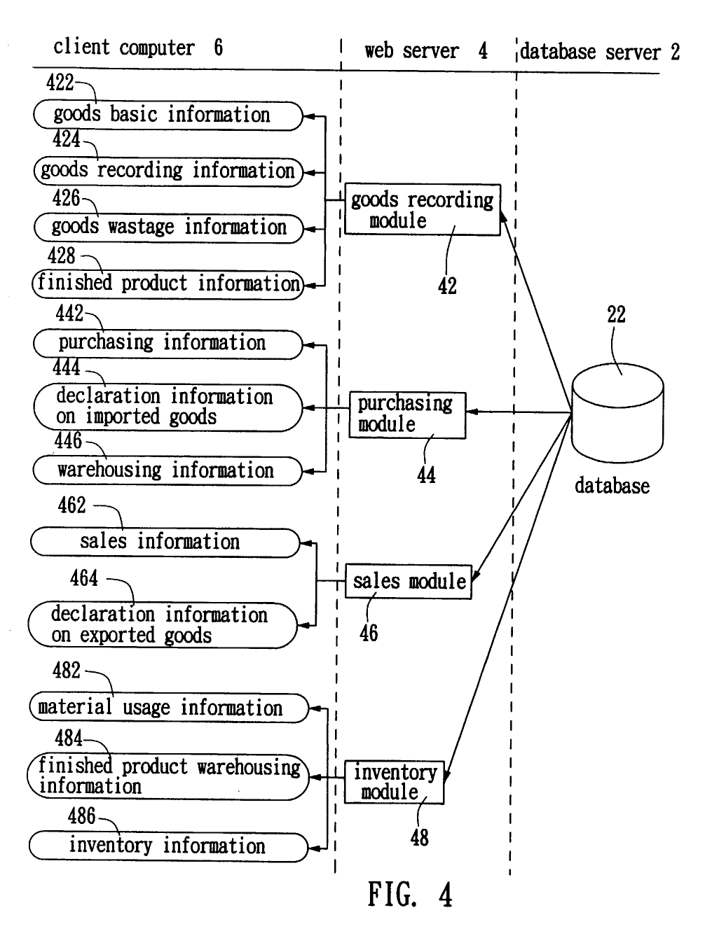

FIG. 4 shows a schematic structure of a Browser/Server (B/S) mode of operation of the collaborative system for monitoring imported and exported goods. The collaborative system for monitoring imported and exported goods runs in a B/S mode. The B/S structure consists of a Database Layer, an Application Layer and a Presentation Layer. The database server 2 belongs to the Database Layer, the web server 4 belongs to the Application Layer, and the client computer 6 belongs to the Presentation Layer. The web server 4 stores four application modules: a goods recording module 42, a purchasing module 44, a sales module 46, and an inventory module 48. Users access the four application modules through the client computer 6 in order to obtain information on import and export business activities.

The goods basic information 422 is related to basic information on imported and exported goods. Users access the goods recording module 42 to obtain goods basic information 422, goods recording information 424, goods wastage information 426, and finished product information 428. In the preferred embodiment, the goods basic information 422 comprises goods no., category of goods, goods name, country of origin, preferential tax rate, general tax rate, entry permit code, measuring unit, and sample pictures. The goods recording information 424 is related to information that is required to be put on record in customs. In the preferred embodiment, the goods recording information 424 comprises goods no., goods name, country of origin, levy type, and handbook number. The goods wastage information 426 is related to goods wastage information recorded in the handbook. In the preferred embodiment, the goods wastage information 426 comprises handbook no., finished goods no., and wastage information. The finished product information 428 is related to basic information on finished products. In the preferred embodiment, the finished product information 428 comprises handbook no., goods no., safety stock, amount of exported goods, import country, and export country.

Users access the purchasing module 44 to obtain purchasing information 442, declaration information on imported goods 444, and warehousing information 446. The purchasing information 442 is related to checking and acceptance information on purchased goods. In the preferred embodiment, the purchasing information 442 comprises purchase order no., purchase type, supplier, goods name, goods no., purchase time, acceptance time, customs declaration no., price, and amount. The declaration information on imported goods 444 comprises, in the preferred embodiment, customs no., amount, customs declaration no., and tax rate. The warehousing information 446 describes warehousing of goods. In the preferred embodiment, the warehousing information 446 comprises goods no., customs declaration no., goods name, amount, and warehouse name.

Users access the sales module 46 to obtain sales information 462 and declaration information on exported goods 464. In the preferred embodiment, the sales information 462 comprises sales order no., shipment date, goods name, and amount. The declaration information on exported goods 464 describes declaration information for export of finished products.

Users access the inventory module 48 to obtain material usage information 482, finished product warehousing information 484, and inventory information 486. The material usage information 482 describes usage of imported materials. The finished product warehousing information 484 describes warehousing of finished products. The inventory information 486 describes current inventory of imported goods, and of finished products that are ready to be exported.

The embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description but rather by the spirit and scope of the claims that follow, and their equivalents.

What is claimed is:

1. A collaborative system for monitoring imported and exported goods, the system comprising:
a database for storing information on import and export business activities; and
a web server for exchanging information between users and the database via an electronic communications network, the web server comprising:
a goods recording module for obtaining from the database that is required to be put on record in a customs authority;
a purchasing module for obtaining from the database purchasing information and declaration information on imported goods;
a sales module for accessing the database for sales information and declaration information on exported goods; and
an inventory module for accessing the database for information on finished goods, usage of materials and current inventory.

2. The collaborative system for monitoring imported and exported goods as claimed in claim 1 further comprising a database server for sending data to and receiving data from the database.

3. The collaborative system for monitoring imported and exported goods as claimed in claim 2, wherein the database server is connected with an internal system via the electronic communications network, and automatically obtains information related to import and export business activities from the internal system.

4. The collaborative system for monitoring imported and exported goods as claimed in claim 3, wherein the internal system is an Enterprise Resource Planning system.

5. The collaborative system for monitoring imported and exported goods as claimed in claim 1, wherein the business activities include purchase, production, storage, sales and declarations for import and export.

6. A collaborative method for monitoring imported and exported goods, the method comprising the steps of:
providing a database for storing information on import and export business activities; and
providing a web server for exchanging information between users and the database via an electronic communications network, the web server comprising:
a goods recording module for obtaining from the database information that is required to be put on record in a customs authority;
a purchasing module for obtaining from the database purchasing information and declaration information on imported goods;
a sales module for accessing the database for sales information and declaration information on exported goods; and
an inventory module for accessing the database for information on finished goods, usage of materials and current inventory.

7. The collaborative method for monitoring imported and exported goods as claimed in claim 6 further comprising the following steps:
sending a query to the web server through a client computer;
receiving the query and automatically transforming the query into a predetermined standard format;
searching the database thoroughly in order to generate a query result; sending the query result to the web server; and
transforming the query result into another predetermined standard format and transmitting the query result to the client computer.

8. The collaborative method for monitoring imported and exported goods as claimed in claim 6 further comprising a step of providing a database server for sending data to and receiving data from the database.

9. The collaborative method for monitoring imported and exported goods as claimed in claim 8, wherein the database server is connected with an internal system via the electronic communications network, and automatically obtains information related to import and export business activities from the internal system.

10. The collaborative method for monitoring imported and exported goods as claimed in claim 9, wherein the internal system is an Enterprise Resource Planning system.

11. The collaborative method for monitoring imported and exported goods as claimed in claim 6, wherein the business activities include purchase, production, storage, sales and declarations for import and export.

12. A method of monitoring imported and exported goods for a customs authority, comprising the steps of:
providing a database server cooperating with an internal system and a corresponding storing database for storing information on import and export business activities of an enterprise; and
providing a web server through which both the customs authority and the enterprise are able to approach the database server.
